(19) United States
(12) Patent Application Publication
(10) Pub. No.: US 2014/0149182 A1
(43) Pub. Date: May 29, 2014

(54) System and Method For Gathering and Processing Data in A Social Network

(71) Applicant: Peter Fuller, New York, NY (US)

(72) Inventor: Peter Fuller, New York, NY (US)

(21) Appl. No.: 14/092,687

(22) Filed: Nov. 27, 2013

Related U.S. Application Data
(60) Provisional application No. 61/730,711, filed on Nov. 28, 2012.

(51) Int. Cl. G06Q 50/00; G06Q 30/02

(52) U.S. Cl. CPC G06Q 50/01; G06Q 30/0203
USPC 705/7.32

(57) ABSTRACT

A social opinion system and method are disclosed. Questions or statements are generated and sent electronically to a plurality of users of a social networking service. A simple response mechanism is generated for display in a user interface with the questions or statements. Data characterizing responses provided by the plurality of users using the simple response mechanism are received by a computer. Real-time information related to the questions or statements is generated by the computer, and provided from the computer via a communication network to at least one designated recipient.

### TECHNICAL FIELD

The subject matter described herein relates to social networking, and more particularly to a system and method for gathering data that can be processed to provide actionable, useful real-time information.

### BACKGROUND

Humans are individualistic, opinioned, yet ultimately herd animals: They like to know what others, individually or collectively, are thinking, as it helps them form culturally acceptable or counter-cultural opinions for use in casual conversation or self-identification.

Much of the appeal of social media is heavily based on people getting access to information about what others are thinking and doing. For instance, the enormous success of a messaging service such as Twitter® proves that people love to express their opinion. People love to be heard, yet neither Twitter® nor any other application or service currently available provides the user with instant, direct data-driven feedback as to whether their opinions, viewpoints or perspectives are consistent with the prevailing conventional wisdom, part of a trend, or are truly as interesting or unique as they think.

A “like” button or feature such as found in several application is a useful feedback tool, but its only applicable and usable to respond to near-random, all-over-the-map, unfocused content. And, as such, like Twitter®, it falls woefully short in terms of generating focused, actionable data.

Basically, from a data collection perspective, both messaging applications and “Like” are passive: people provide their opinions, others contributing their “Like” (with no ability to “Dislike” or “Disagree” or provide any other gradient of feedback). Because the starting content is near-random, and clear demographic data is not available, statisticians are unable to truly sort-out trends and shifts in public opinion.

There are some websites that focus on generating interesting data, for example, survey-based websites. However, surveys tend to be issue/theme-driven, thus their audience is limited, to the survey's detriment, to a select segment of the population, mostly those individuals who are willing to participate.

### SUMMARY

This document describes systems and methods for generating useful, timely, valuable and actionable marketing data, including the ability to identify trends, gauge messaging effectiveness and foresee rapidly changing public opinion. These systems and methods provide more useful and actionable data than mere “like” buttons or “share” buttons encoded into traditional social networking services, for sharing information to one's network of “friends” or social graph.

Implementations of the current subject matter can include, but are not limited to, systems and methods consistent including one or more features are described as well as articles that comprise a tangibly embodied machine-readable medium operable to cause one or more machines (e.g., computers, etc.) to result in operations described herein. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to an enterprise resource software system or other business software solution or architecture, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is a flowchart of a method for a social opinion system.

When practical, similar reference numbers denote similar structures, features, or elements.

### DETAILED DESCRIPTION

To address these and potentially other issues with currently available solutions, methods, systems, and the like consistent with one or more implementations of the current subject matter can, among other possible advantages, provide real-time, useful and actionable data based on user responses to thought-provoking, yet quickly answerable statements or questions, all of which is executed on a computing system, and some or all of which can be executed via an application running on a user computing device such as a mobile phone, laptop computer, or desktop computer. The systems and methods described herein, collectively and individually referred to as a social opinion system, enable the generation and dissemination of useful and actionable data to users of the application in real-time. The data can be textual, graphical, or otherwise representative of analytics or processing performed on the data. The social opinion system is an application that leverages this fact to generate useful, demographically defined data on what people are thinking, their preferences and their concerns.

The social opinion system leverages the power of social media, and exploits modern users' short attention span, as well as users' needs to be “heard” by other users, to generate the useful and actionable data. The social opinion system provides users with an entertaining, low-overhead, quick, easy and interactive way to express their opinion: random or targeted questions or statements will be randomly or actively presented, to which the user can provide a quick answer via simple response mechanism. The simple response mechanism can be displayed in the user interface that displays a social networking application, for instance, or be displayed in a pop-up window. The simple response mechanism can be a locally generated interface, as a plug-in to an application or the like.

For example, a user can provide to the simple response mechanism, via an input device of a computing system, an answer to a question or opinion to a statement. The answer can be one on a scale or gradient of potential answers, such as, for example, “highly agree,” “somewhat agree,” “somewhat disagree,” “highly disagree” and “don't care.” Alternatively, depending on the statement or question, the responses may be “Really like”, etc. or the user will be presented with a set of multiple-choice answers. The response does not require, nor even allow, blogging or discussion in the initial response.

Importantly, the social opinion system provides users with an incentive to participate. If an individual chooses to participate or interact with the social opinion system, he or she will be entitled to get real-time feedback about what others (in their self-described demographic and the whole population at-large) are thinking about the topic. Essentially, the user will be able to obtain, via a messaging or other application, a real-time answer to “Are my opinions/interests like everyone else's or am I really different?”

In an exemplary implementation, the social opinion system can be part of a social networking application or service, such as Facebook®, i.e. as an application within an application. Members of the social networking service have instant access. And, users can opt to have their friends see their responses and opinions, thus driving significant increases in membership, which will results in higher quality data.

Content-Oriented (e.g. questions and statements)

The statements and questions can be categorized according to one or more categories, such as, for example, fashion, politics, people, movies, products, and even sex. Other categories or subcategories are possible. Further, the questions can be based on demographic segments of the user-base, or directed toward the entire user-base. The statements and questions can be varied, intriguing, provocative, topical, timely and relevant, thus creating an incentivized need for the user to view and follow theirs and others' responses.

The lure is that the statements or questions are intriguing, and the user needs only spend a few seconds expressing their opinion in response to the statements or questions. In return, users get real-time data about others in their self-defined demographic, and potentially, the entire membership. The real-time data is generated on-the-fly by the social opinion system, and based on the responses provided by the users. The real-time data can be augmented with analytics performed on the data, such as segmentation or mapping of responses with user-specific or demographic information.

Ultimately, the questions could be structures to gain insight into a broad set of opinions and perceptions. Various entities, from product companies to political organizations, (third party entities) can pay to have information generated and tailored for their specific needs, or if already collected, the data may be valuable to such companies or organizations. While the data would not be strictly scientific, it would be relevant for spotting emerging trends and shifts in public opinion, or even determining if a company's or organization's message is being heard.

The third party entities can use the information to quickly learn which kinds of questions and topics drive responses. This information, as well as advice from the company's product companies and political organizations (etc.) partners, and users themselves (such as after 500 response, they will be entitled to submit questions for consideration) will further help in the design of questions and statements.

Business Opportunity

As an application that can be integrated with one or more social networking services such as Facebook® or Twitter®, once a user signs up for the social opinion system, or uses their social networking profile to gain access to the application, he or she may elect to give their friends access to their opinions (e.g. responses). This will drive significant traffic, thus increasing the value of the social opinion system platform. The social opinion system enables sales of 1) existing market-relevant, demographically defined data, and 2) proactive surveys to marketers and others interested in emerging trends, messaging and/or real-time, dynamic changes in public opinion.

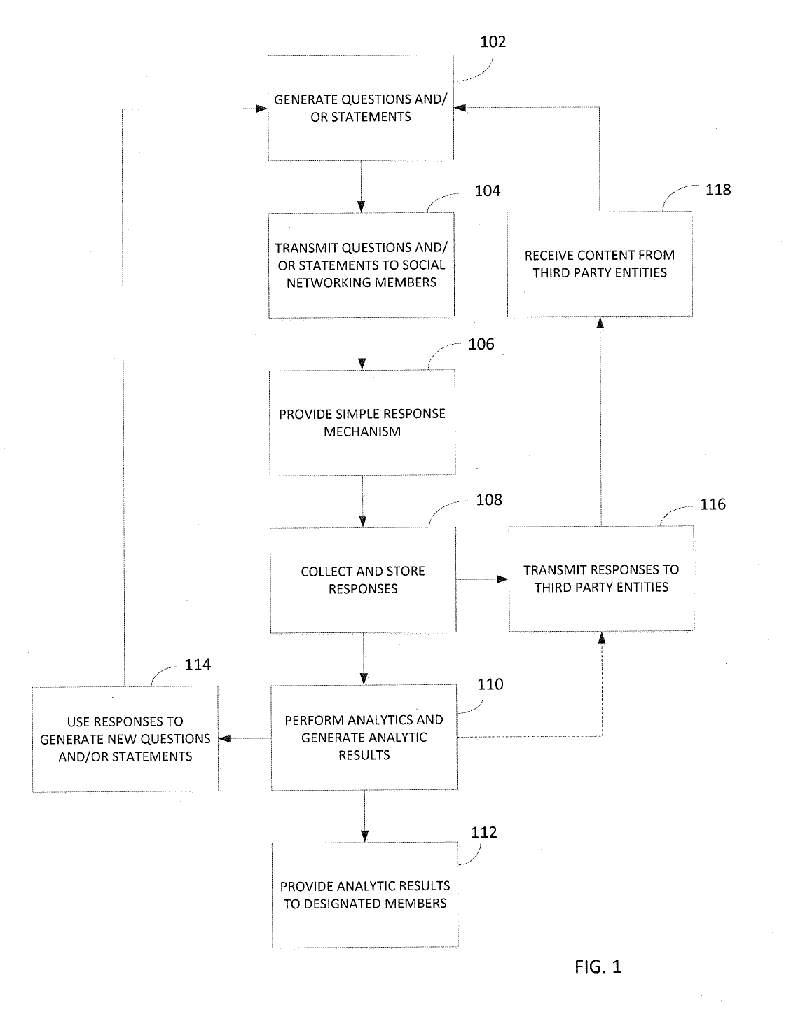

FIG. 1 is a flowchart of a method for a social opinion system. At 102, a number of questions and/or statements are generated. The questions and/or statements can be generated by a computer based on prevailing trends, popular content, or other content on a network or computer communication system, or can be generated by any of a number of users and input into the computer. At 104, the questions and/or statements are transmitted to members of one or more social networking services. The transmission can occur within an application providing the social networking service, to a separate browser application, or to a dedicated window of a user interface on a client computer. The client computer can be any of a desktop or laptop computer, or any mobile computing device. Further, the transmission can be in a messaging application, or can cause a local application on the client computer to display the questions and/or statements.

At 106, a simple response mechanism is provided with the questions and/or statements. The simple response mechanism can include any number of links, buttons or other graphical or textual feature that can be selected by a user using an input device to designate their selection. In some implementations, the simple response mechanism provides a scale or gradient of possible responses, each of which can be selected by the user to indicate their response to the questions and/or statements. The response, in turn, reflects an opinion by the user that provides actionable information. The responses from all responding user are transmitted to the computer, collected, and stored in a database. The database and computer can do any of a number of forms of aggregation and/or organization of the responses, i.e. based on demographics, preferences, time, etc.

At 108, analytics are performed on the results. For instance, the results can be aggregated and an average, or common, response generated. Alternatively, all of the responses can be graphed according to a weighting schema to display a relative weight of each response, such as frequency or number of each of the possible responses, within a given timeframe. At 110, the analytic results are provided to designated members, in real-time or near-real-time, preferably. Accordingly, by participating in responding to the questions and/or statements, a user can get near real-time feedback of where their responses fit within the analytic schema or structure, i.e. how they compare against other members.

At 114, the responses can be used to generate other questions and/or statements. For instance, the high-volume questions and/or statements can be used to generate other questions and/or statements in a similar topic of interest, or a completely different theme. At 116, responses or, alternatively or in combination, analytic results, can be transmitted to third party entities, such as businesses, political groups or other interest groups. The third party entities can perform their own, specialized or tailored analytics on the responses or analytic results, and can generate further content for further questions and/or statements. At 118, the further content is provided to the computer to generate more questions and/or statements.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT), a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method comprising:
sending questions or statements to a plurality of users of a social networking service;
providing a simple response mechanism for display in a user interface with the questions or statements;
receiving, at a computer and based on responses provided by the plurality of users using the simple response mechanism, data characterizing the responses to the questions or statements;
processing, by the computer, the data to generate real-time information related to the questions or statements; and
providing, from the computer via a communication network, the real-time information to at least one designated recipient.

2. The method in accordance with claim 1, wherein the simple response mechanism provides a plurality of user-selectable responses, each of the plurality of user-selectable responses being one along a gradient of potential responses.

3. The method in accordance with claim 1, further comprising aggregating the responses provided by the plurality of users to generate a common response.

4. A computer program product comprising a machine-readable medium storing instructions that, when executed by at least one programmable processor, cause the at least one programmable processor to perform operations comprising:
send questions or statements to a plurality of users of a social networking service;
provide a simple response mechanism for display in a user interface with the questions or statements;
receive, based on responses provided by the plurality of users using the simple response mechanism, data characterizing the responses to the questions or statements;
process the data to generate real-time information related to the questions or statements; and
provide the real-time information to at least one designated recipient.

5. A system comprising:
at least one programmable processor; and
a machine-readable medium storing instructions that, when executed by the at least one processor, cause the at least one programmable processor to perform operations comprising:
sending questions or statements to a plurality of users of a social networking service;
providing, with the questions or statements, a simple response mechanism;
receiving, based on responses provided by the plurality of users using the simple response mechanism, data characterizing the responses to the questions or statements;
processing the data to generate real-time information related to the questions or statements; and
providing the real-time information to at least one designated recipient.
